(19) United States
(12) Patent Application Publication
(10) Pub. No.: US 2022/0058756 A1
(43) Pub. Date: Feb. 24, 2022

(54) SYSTEMS AND METHODS FOR CALCULATING AND CONVERTING UNITS OF REITS

(71) Applicant: Legendary Capital, LLC, Fargo, ND (US)

(72) Inventors: Corey Maple, Fargo, ND (US); David Durell, Fargo, ND (US); Norman Leslie, Fargo, ND (US)

(21) Appl. No.: 17/410,534

(22) Filed: Aug. 24, 2021

Related U.S. Application Data
(60) Provisional application No. 63/069,429, filed on Aug. 24, 2020.

(51) Int. Cl. G06Q 50/16; G06Q 40/06

(52) U.S. Cl. CPC G06Q 50/167; G06Q 40/06

(57) ABSTRACT

A method includes accepting title to real estate by an operating partnership of a real estate investment trust, determining a number of transition units of the operating partnership based on an attribute of the real estate, distributing the determined number of transition units in exchange for accepting the title to the real estate, calculating a value of the transition units based on actual performance of the real estate, and converting the transition units to common units of the operating partnership based on the calculated value.

### CROSS-REFERENCE TO RELATED APPLICATION

This application claims priority to U.S. Provisional Application No. 63/069,429, filed Aug. 24, 2020, which is herein incorporated by reference in its entirety.

### SUMMARY

Certain embodiments, systems and methods are disclosed for calculating and converting units of an operating partnership. Embodiments can include accepting title to real estate by an operating partnership of a real estate investment trust, determining a number of transition units of the operating partnership based on an attribute of the real estate, distributing the determined number of transition units in exchange for accepting the title to the real estate, calculating a value of the transition units based on actual performance of the real estate, and converting the transition units to common units of the operating partnership based on the calculated value.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a schematic of an UPREIT, in accordance with certain embodiments of the present disclosure.

FIG. 2 shows a block diagram of steps of a method for calculating values of transition units and converting the transition units to common shares, in accordance with certain embodiments of the present disclosure.

FIG. 3 shows a block diagram of components of a system for carrying out the method of FIG. 2, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

A real estate investment trust (REIT) is a type of corporation that invests in real estate and that is subject to its own set of rules in the United States' tax code. RE ITs can acquire real estate in different ways. As examples, REITs can acquire real estate through a direct purchase for cash or through a contribution of the real estate in exchange for shares of the REIT. For another example, REITs can acquire real estate through what is referred to as an umbrella partnership REIT (UPREIT).

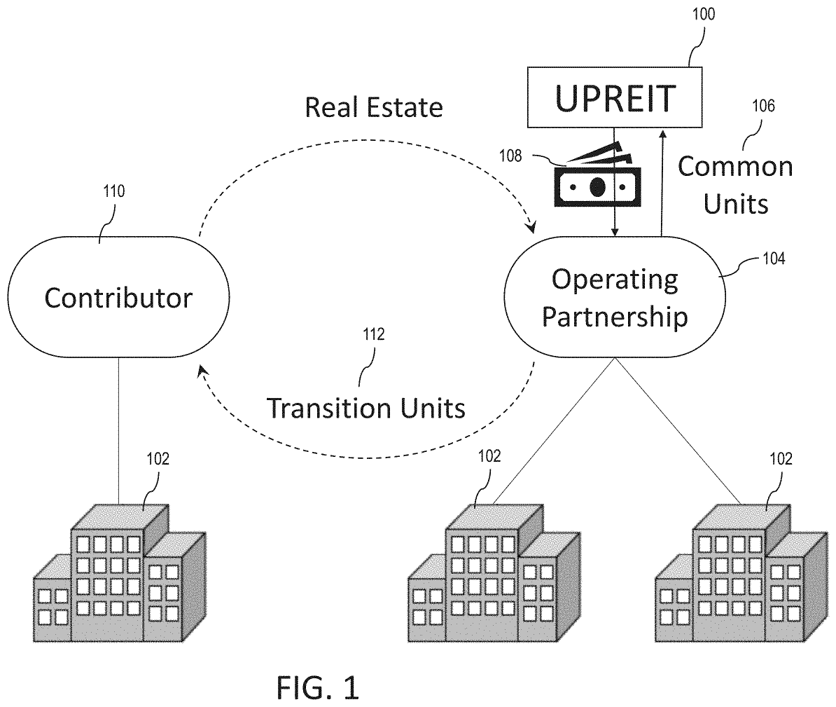

FIG. 1 shows a schematic of an UPREIT 100. With an UPREIT 100, instead of the REIT directly owning property once such property is acquired, the UPREIT's real estate 102 is indirectly owned through a partnership 104 of the UPREIT 100. The partnership 104 is typically referred to as an operating partnership, which operates subject to determined rules of the partnership.

The UPREIT 100 directly owns interest in the operating partnership 104 in the form of units 106. The UPREIT 100 can contribute capital 108 to the operating partnership 104 in exchange for the ownership units 106, and the capital 108 can be used to acquire and manage (e.g., operate, maintain, improve) the real estate 102 owned by the operating partnership 104. In certain embodiments, the real estate 102 owned by the operating partnership 104 is limited to a certain class or type of properties such as only hotels or only commercial office buildings. Of course, the real estate 102 can include different mixes of types of properties.

Those who contribute the real estate 102 to the UPREIT 100 can defer taxes on the contribution of the real estate 102. Based on the valuation of the contributed real estate, contributors 110 receive a certain number of the ownership units (e.g., transition units 112) of the operating partnership 104 in exchange for the contributed real estate 102. Under section 721 of the current tax code, such an exchange is not considered to be a taxable event.

One of the challenges of operating UPREITs 100 is determining the value of the real estate 102 at the time the real estate 102 is contributed. This is particularly challenging when the valuation occurs during an economic downturn or when the future income of a given parcel of real estate is otherwise uncertain. The contributor 110 may be over- or under-compensated in the form of units if a static valuation is determined at the time of the contribution, which would have either an overall accretive or dilutive effect on all unitholders. Regardless, there is a high probability of inappropriately valuing real estate 102 at that time. Moreover, if the contributed real estate 102 fails to meet the performance requirements assumed at the time of evaluation, the overall performance of the UPREIT 100 will be negatively affected. To address this performance risk, the UPREIT 100 may assume relatively low valuations on potential real estate. However, it may be difficult to find willing contributors 110 if the valuations are too low.

Certain embodiments of the present disclosure are accordingly directed to approaches for providing mutually-acceptable real estate valuations while providing improved performance of UPREITs.

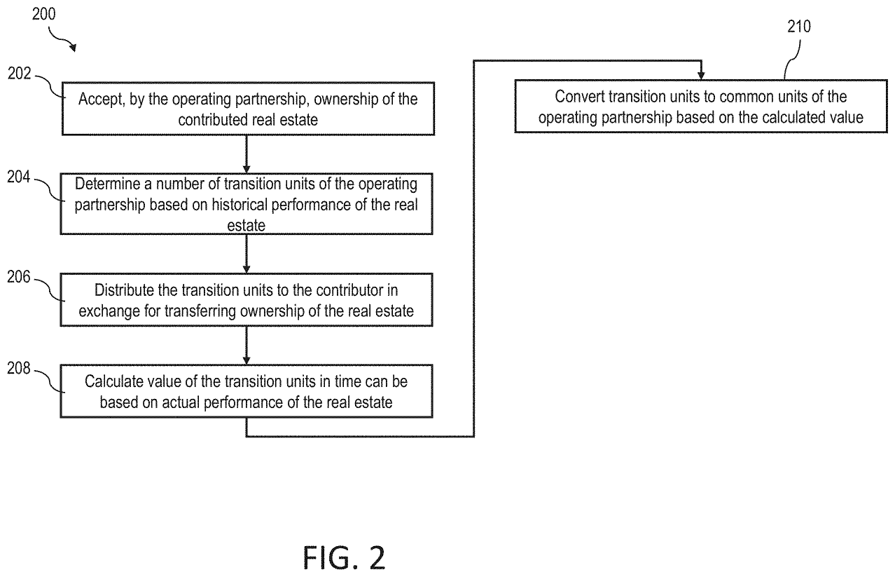

FIG. 2 outlines various steps of a method 200 for calculating values of transition units and converting the transition units to common units of the operating partnership 104 which ultimately can be converted to common shares of the UPREIT 100. The various steps of the method 200 described below can be carried out in different orders and can be carried out in parallel and/or serially.

The method 200 includes accepting, by the operating partnership 104, ownership of the contributed real estate 102 (block 202 in FIG. 2). This may include accepting the title to the real estate as evidenced by a legal instrument such as a deed. The deed can be recorded at the appropriate municipality.

The method 200 further includes determining a number of transition units 112 of the operating partnership 104 based on historical performance of the real estate 102 (block 204 in FIG. 2). In certain embodiments, the historical performance is or includes the prior year's financial performance. For example, if the real estate 102 is being evaluated in March 2020, the prior year's financial performance can include the performance over the past 12 months (e.g., trailing 12 months from March 2019 to February 2020), the past full calendar year (e.g., January 2019 to December 2019), or the past full fiscal year of the entity contributing the real estate 102. As another example, the historical performance can include 1-, 3-, or 5-year proformas for the real estate 102. As another example, the historical performance can include an appraisal. In certain embodiments, the historical performance is limited only to the past year's performance and not to earlier years.

The financial performance can be determined based, at least in part, on a desired capitalization rate of the real estate 102. The capitalization rate is the ratio of the net operating income of the real estate 102 to the asset value of the real estate. For example, if a given piece of real estate sold for $5,000,000 and had a net operating income of $500,000, then the capitalization rate would be 10% (i.e., $500,000 divided by $5,000,000). In determining the value of the real estate 102 to be contributed to the UPREIT 100, the operating partnership 104 can set a desired capitalization rate (e.g., 10%, 11%, 12%). That set capitalization rate and the past year's net operating income of the real estate 102 can then be used to determine the value of the real estate 102. The applied capitalization rate can be set at different rates for different contributors 110. For example, the capitalization rate for one contributor 110 can be set of 10% while the capitalization rate for a different contributor 110 can be set higher at 11.5%.

In certain embodiments, the number of transition units 112 for a given piece of real estate can be determined without being based on any future or projected performance of the real estate 102. Using only historical performance (e.g., the past year's performance, proformas, appraisals) in determining the number of transition units 112—particularly during an economic downturn—is counterintuitive. However, using historical performance establishes a valuation that is likely to be acceptable to those who are contributing the real estate 102. As described further below, the valuation of the transition units 112 can change after the initial valuation, which is made at the time the real estate is contributed to the operating partnership 104.

In certain embodiments, when the real estate 102 is contributed, the operating partnership assumes or defeases debt or takes out new debt associated with the contributed real estate 102. The assumption, defeasance, or new debt issuance can occur contemporaneously with contribution of the real estate 102. In such embodiments, the number of transition units 112 for a given piece of real estate is reduced by the amount of the debt.

Once the number of transition units 112 is determined, those transition units 112 can be distributed to the contributor 110 in exchange for transferring ownership of the real estate 102 (block 206 in FIG. 2). As such, immediately after the exchange or transaction, the contributor 110 owns the transition units 112 and the operating partnership 104 owns the contributed real estate 102. This exchange or transaction occurs without money or cash being transferred between the parties. However, in certain embodiments, a limited amount of money or cash may be transferred from the operating partnership 104 to the contributor 110 at the time of exchange or transaction.

After the exchange, the operating partnership 104 is responsible for managing the contributed property. For example, the operating partnership 104 is responsible for paying for maintenance, operating expenses, improvements, and the like of the real estate 102. In certain embodiments, the operating partnership 104 and the contributor 110 mutually select a management company as part of the transaction.

The transition units 112 transferred to a given contributor 110 can be associated with rules or requirements (e.g., as provided under a contract) that are unique to the specific real estate 102 contributed by the contributor 110. For example, under terms of a contract, the transition units 112 can be given or associated with characteristics that are based on the actual financial performance of the contributed real estate 102. The characteristics of the transition units 112 may vary in concert with varying financial performance of the contributed real estate 102. Put another way, the characteristics of the transition units 112 can track the actual performance of the real estate 102. For example, given transition units 112 may receive distributions or dividends based on the actual performance of the associated real estate 102. As another example, given transition units 112 may receive varying levels of income or loss allocation from the operating partnership 104. As another example, given transition units 112 may receive varying hold period before the contributor 110 is able to transition, convert, or transfer such units.

In certain embodiments, the value of the transition units 112 is determined or revaluated after a set period of time. For example, the transition units 112 can be reevaluated 1-5 years (e.g., 2 years, 3 years) after the transition units 112 were distributed to a given contributor 110. The specific period of time between the initial valuation and the revaluation can be dictated by a contract between the operating partnership 104 and the contributor 110.

The value of the transition units 112 at the later point in time can be based on the past year's financial performance (block 208 in FIG. 2), and the financial performance can be measured using the same approach used for determining the initial value of the contributed real estate 102. For example, the past year's net operating income and the set capitalization rate can be used for the initial valuation and subsequent valuation. If the net operating income at the time of the revaluation is less than the net operating income at the time of contribution, the value of the transition units 112 can be reduced by a corresponding amount. For example, if the net operating income has been reduced by 10% at the time of revaluation, the current value of the transition units 112 can likewise be reduced by 10%. As another example, if the net operating income is the same at revaluation, the current value of the transition units 112 would be the same as the value when the real estate 102 was contributed.

In certain embodiments, the value of the transition units 112 at revaluation can be reduced by offsets. For example, the value of the transition units 112 at revaluation can be reduced by amounts incurred or accrued by the operating partnership 104 in closing the real estate 102, operating the real estate 102, or improving the real estate 102, through, as an example, a property improvement plan or capital expenditures. As another example, the value of the transition units 112 at revaluation can be reduced by the amount of the assumed debt or originated debt. As another example, the value of the transition units 112 at revaluation can be reduced by amounts incurred or accrued by the operating partnership 104 to assume outstanding debt, defease outstanding debt, or originate new debt. As another example, the value of the transition units 112 at revaluation can be reduced by a stated minimum yield on the operating partnership's or the UPREIT's invested capital. In one embodiment, the value of the transition units 112 at revaluation is reduced by all of the above-noted amounts.

This revaluation can occur before the transition units 112 are converted to common units 106 of the operating partnership 104. As such, the investors who own the common units 106 limit the risk that the common units are diluted or underperform when the transition units 112 are ultimately converted to common units 106. However, the investors assume certain risk of maintaining or operating the property. In certain embodiments, before the transition units 112 are converted to common units 106, certain expenses and costs are subtracted from the calculated value of the contributed real estate 102.

Once the ultimate value of the contributed real estate 102 is calculated, the transition units 112 can be converted to common units 106 of the operating partnership 104 based on the calculated value (block 210 in FIG. 2). After the conversion, the contributors 110 have the same rights under the operating partnership 104 as other holders of the common units 106.

In certain embodiments, the common units 106 of the operating partnership 104 are converted into common shares of the UPREIT 100. For example, in the event the UPREIT 100 liquidates, the common units 106 can be converted to common shares. When such a conversion occurs, the contributor(s) 110 can participate in returns and/or capital gains resulting from the sale either of the contributed real estate 102 or from the sale of the entire portfolio of real estate 102 of the UPREIT 100.

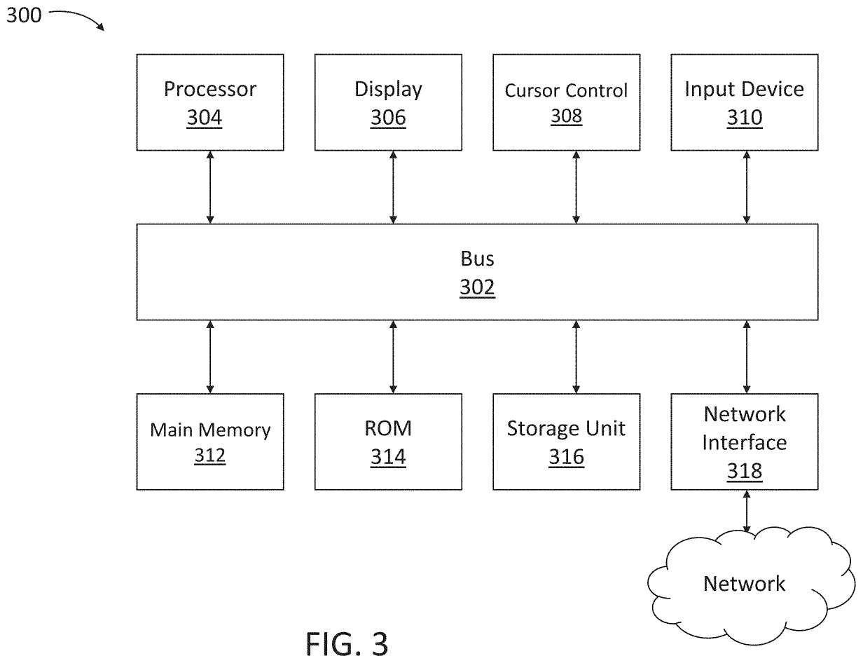

FIG. 3 shows a block diagram of illustrative components of a computer system 300 for carrying out aspects of the method 200 described above. For example, in some embodiments, prior to the processes (e.g., steps) of the method 200 being performed, additional processes occur which may be performed by the computing system 300. For example, additional processes including but not limited to underwriting of the real estate 102 occur before the processes of method 200. Such initial underwriting may be performed using a computing system 300. This diagram is merely an example, which should not unduly limit the scope of the claims.

The computing system 300 includes a bus 302 or other communication mechanism for communicating information between or among a processor 304, a display 306, a cursor control component 308, an input device 310, a main memory 312, a read only memory (ROM) 314, a storage unit 316, and/or a network interface 318. In some examples, the bus 302 is coupled to the processor 304, the display 306, the cursor control component 308, the input device 310, the main memory 312, the ROM 314, the storage unit 316, and/or the network interface 318. And, in certain examples, the network interface 318 is coupled to a network 320.

In some examples, the processor 304 includes one or more general purpose microprocessors. In some examples, the main memory 312 (e.g., random access memory (RAM), cache and/or other dynamic storage devices) is configured to store information and instructions to be executed by the processor 304. In certain examples, the main memory 312 is configured to store temporary variables or other intermediate information during execution of instructions to be executed by processor 304. For example, the instructions, when stored in the storage unit 316 accessible to processor 304, render the computing system 300 into a special-purpose machine that is customized to perform the operations specified in the instructions (e.g., the method 200). In some examples, the ROM 314 is configured to store static information and instructions for the processor 304. In certain examples, the storage unit 316 (e.g., a magnetic disk, optical disk, or flash drive) is configured to store information and instructions.

In some embodiments, the display 306 (e.g., an LCD display or a touch screen) is configured to display information to a user of the computing system 300. In some examples, the input device 310 (e.g., alphanumeric and other keys) is configured to communicate information and commands to the processor 304. For example, the cursor control 308 (e.g., a mouse, a trackball, or cursor direction keys) is configured to communicate additional information and commands (e.g., to control cursor movements on the display 306) to the processor 304.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A method comprising:
accepting, by an operating partnership of a real estate investment trust (REIT), title to real estate;
determining a number of transition units of the operating partnership based on an attribute of the real estate;
distributing the determined number of transition units in exchange for accepting the title to the real estate;
calculating a value of the transition units based on actual performance of the real estate; and
converting the transition units to common units of the operating partnership based on the calculated value.

2. The method of claim 1, wherein the attribute is historical performance calculated based on a past year's net operating income of the real estate.

3. The method of claim 2, wherein the determining the number of transition units is further based on a capitalization rate.

4. The method of claim 2, wherein the past year is a past full calendar year, a trailing 12 months, or a past full fiscal year.

5. The method of claim 1, wherein the determining the number of transition units is not based on future or projected performance of the real estate.

6. The method of claim 1, wherein the attribute is historical performance, wherein the actual performance of the real estate is calculated using an approach that is the same as the approach used to determine the historical performance.

7. The method of claim 1, wherein the distributing the determined number of transition units includes transferring legal title to the transition units to a contributor of the real estate.

8. The method of claim 1, wherein the calculating the value of the transition units occurs 1-5 years from a date the accepting title to real estate occurs.

9. The method of claim 1, wherein the calculating the value of the transition units occurs 6-10 years from a date the accepting title to real estate occurs.

10. The method of claim 1, wherein the calculating the value of the transition units is further based on subtracting expenses of the real estate.

11. The method of claim 10, wherein the calculating the value of the transition units is further based on subtracting costs incurred by the operating partnership in connection with accepting the title to the real estate.

12. The method of claim 1, wherein the calculating the value of the transition units is further based on subtracting amounts incurred or accrued to assume debt, defease debt, or originate new debt.

13. The method of claim 1, wherein the determining the number of transition units of the operating partnership is further based on debt, which is associated with the real estate and which is either assumed or defeased by the operating partnership.

14. The method of claim 1, further comprising:
converting the common units of the operating partnership to common shares of the REIT.

15. The method of claim 14, wherein the converting the common shares is in response to either the real estate being sold by the operating partnership or the REIT liquidated its portfolio of property.

16. The method of claim 1, wherein the REIT is an umbrella partnership REIT (UPREIT).

17. A system comprising:
memory that stores instructions; and
one or more processors configured to execute the instructions to perform the following:
determine a number of transition units of an operating partnership of a real estate investment trust (REIT) based on an attribute of contributed real estate,
calculate a value of the transition units based on actual performance of the real estate, and
convert the transition units to common units of the operating partnership based on the calculated value.

18. The system of claim 17, wherein the attribute is historical performance calculated based on a past year's net operating income of the real estate.

19. The system of claim 17, wherein the number of transition units is further based on a capitalization rate.

20. The system of claim 17, wherein the one or more processors are furthered configured to execute the instructions to convert the common units of the operating partnership to common shares of the REIT.
